(19) United States
(12) Patent Application Publication
(10) Pub. No.: US 2010/0110174 A1
(43) Pub. Date: May 6, 2010

(54) METHOD FOR DEVICE FOR DETECTING LOW-CONTRAST AND HIGH-CONTRAST DEFECTS IN TRANSPARENT OR TRANSLUCENT OBJECTS

(76) Inventor: Marc Leconte, Loire Sur Rhone (FR)

Correspondence Address: CLARK & BRODY, 1090 VERMONT AVENUE, NW, SUITE 250, WASHINGTON, DC, 20005, US

(21) Appl. No.: 12/312,035

(22) PCT Filed: Oct. 24, 2007
(86) PCT No.: PCT/FR2007/052238

§ 371 Date: Jan. 5, 2010

(30) Foreign Application Priority Data
Oct. 24, 2006 (FR) 0654489

(51) Int. Cl. H04N 7/18

(52) U.S. Cl. 348/92; 348/E07.085

(57) ABSTRACT

The invention concerns an optical inspection method for the line inspection of transparent or translucent objects (2) travelling at fast rate between a light source (3) and means (4) to take images of the objects and to analyze the images taken, so as to detect defects in the objects.

According to the invention, the method consists of:
controlling the single light source (3) so that said source successively produces two types of illumination for each object travelling in front of said source, the first type being homogeneous illumination whilst the second type is formed of alternate dark areas (s) and light areas (c) with discontinuous spatial variability,
taking images of each travelling object when each thereof is successively illuminated by both types of lighting,
and analyzing the images taken with the first and second types of illumination, with a view to detecting high contrast defects and low contrast defects respectively

The present invention concerns the technical area relating to the optical inspection of translucent or transparent objects, with a view to detecting any defects in these objects.

The subject-matter of the invention finds particularly advantageous application in the detection of light-absorbing and/or light-refracting defects which may appear in objects such as containers in glass or plastic material.

Automatic, production-line inspection is known for objects travelling at fast rate in front of an optical inspection station comprising a light source located on one side of the object and a camera located on the other side. The camera takes an image using the light passing through the objects. This illumination principle is known as transmission illumination.

Under these observation conditions, with a uniform light source that is outspread relative to the inspected object, the defects of these objects behave differently depending on their type and shape and can be classified into two categories. Some of these defects such as inclusions of non-transparent material absorb light and, less frequently, pronounced creases or surface defects strongly reflect the light. Under these observation conditions, these defects show a deep contrast in the image and are considered as high-contrast defects. Other less marked refractive defects such as seeds, surface rumples or local variations in the thickness of the transparent material, under these observation conditions, cause insufficient contrast in the image for their detection. Similarly, defects such as smear marks diffuse the light and cannot be detected under these conditions of observation.

These refractive and diffusing defects are called low-contrast defects.

In an attempt to detect low-contrast defects, it is known from EP 148 725, U.S. Pat. No. 5,004,909 or EP 0 344 617 for example to use a test pattern as illumination source, consisting of alternate black and white stripes. The striped pattern observed through the object is locally deformed in the presence of low-contrast defects. Processing of the images detects the transitions at the transit points between the black and white stripes. The major drawback with said technique lies in the impossible proper detection of high contrast defects which may lie in the black striped parts of the image corresponding to the black stripes of the test pattern. Therefore to ensure reliable detection of high-contrast defects and low-contrast defects, it appears necessary to cause the objects to travel successively in front of two different optical inspection stations, which leads to relatively high inspection costs and takes up space on the production line. To endeavour to overcome this drawback, patent FR 2 794 242 proposed creating sufficiently slow variations in light at the illumination source so that they are not detected as defects but rather have a contrast-enhancing effect for low-contrast defects. This solution has the advantage of using a single light source to detect two types of defects. However, it appears that variations in light between different regions of the illumination source cannot be perceived in the form of deformed pattern lines, meaning that it is not possible to detect refractive defects of very low contrast.

Also, document EP 1 494 012 describes an inspection machine comprising several types of illumination sources, each adapted to detect a specific type of defect. The machine comprises a man-machine interface allowing the illumination source to be selected in relation to the type of defect to be detected. Said machine does not allow production-line detection of defects involving several types of defects in objects travelling at fast speed.

The object of the invention is to overcome the disadvantages of the prior art by proposing a novel technique which allows correct, low-cost detection of low-contrast defects and high-contrast defects which may occur in transparent or translucent objects travelling at a fast production rate.

The subject of the invention is a method for optical production-line inspection of transparent or translucent objects travelling at a fast rate between a light source and means to take images of the objects and to analyze the images taken, so as to detect defects in the objects.

According to the invention, the method consists of:
controlling the single light source (3) so that said source successively produces two types of illumination for each object travelling in front of said source, the first type being homogeneous illumination whilst the second type is formed of alternate dark areas and light areas with discontinuous spatial variability,
taking images of each travelling object when each thereof is successively illuminated by both types of lighting,
and analyzing the images taken with the first and second types of illumination, with a view to detecting high contrast defects and low contrast defects respectively.

According to one preferred embodiment, the method consists of controlling the light source so that the second type of illumination is formed of alternate dark areas and light areas with discontinuous spatial variation occurring in a periodic cycle which may or may not have a constant value.

More precisely, the method consists of controlling the light source so that the second type of illumination with cyclic discontinuous spatial variation, for each cycle, comprises:
a phase maintaining, over a nonzero length (L_{H}), a high level of light intensity at a substantially constant value,
a phase maintaining, over a nonzero length (L_{B}), a low level of light intensity at a substantially constant value,
and transition phases between the high and low levels of light intensity having respective lengths.

Advantageously, the method consists of controlling the light source so that the lengths of the transition phases tend towards a zero length.

Preferably, the method consists of controlling the light source so that the high level light intensity is at least greater than the low level light intensity, with the high level light intensity being at least sufficient to pass through the objects whilst the low level light intensity tends towards a value of zero.

According to another example of embodiment, the method consists of controlling the light source so that the high levels (and respectively the low levels) of light intensity of the light (and respectively dark) areas have different values for different cycles.

A further object of the invention is to propose an optical production-line inspection device to inspect transparent or translucent objects travelling at fast speed between a light source and means for taking images of the objects and analysing the images taken, in order to detect defects in the objects.

According to the invention, the device comprises:
means (9) to control the single light source (3) so that said light source successively produces two types of illumination when each object travels between the light source (3) and the image taking and analysis means (4), the first type being homogenous illumination whilst the second type is illumination formed of alternate dark areas and light areas with discontinuous spatial variability,
and means (4) to take images of each object illuminated by both types of lighting and to process the images taken with the first and second type of illumination, with a view to detecting. high contrast defects and low contrast defects respectively.

According to a first variant of embodiment, the light source consists of a series of elementary sources grouped into adjacent zones independently controlled with respect to light intensity and/or illumination time, a light guide being arranged in front of each zone so as to obtain light of homogeneous intensity at the output of each guide.

For example, each light guide consists of a parallelepiped of transparent material.

According to another example, each light guide consists of a channel delimited by walls of which at least some separate the light guides from each other.

Preferably, at least one diffuser is inserted on the pathway of the light emitted by the elementary sources.

According to another variant of embodiment, the light source consists of a source of uniform light in front of which a liquid crystal display is placed that is controlled so that it makes determined areas opaque or transparent.

According to another variant of embodiment, the light source consists of a system projecting images onto a capture screen, the images corresponding either to a light homogeneous image or to an image containing alternate dark areas and light areas with discontinuous spatial variation.

According to another variant of embodiment, the light source consists of a series of organic light-emitting diodes grouped into adjacent zones independently controlled with respect to light intensity and/or illumination time.

According to one advantageous characteristic, a screen that is controlled electrically to assume either a transparent state or a diffusing state is arranged on the pathway of the light of the light source.

According to another variant of embodiment, the light source consists of elementary sources grouped into zones controlled independently with respect to light intensity and/or illumination time, a screen controlled electrically to assume either a transparent state or a diffusing state being arranged on the light path.

Advantageously the device comprises a linear or circular polarizing filter in front of the light source, and a linear or circular filter in front of the image-taking means.

Various other characteristics will become apparent from the description given below with reference to the appended drawings, given as non-limiting examples, describing embodiments of the subject of the invention.

FIG. 1 is a diagram of a production-line optical inspection device conforming to the invention.

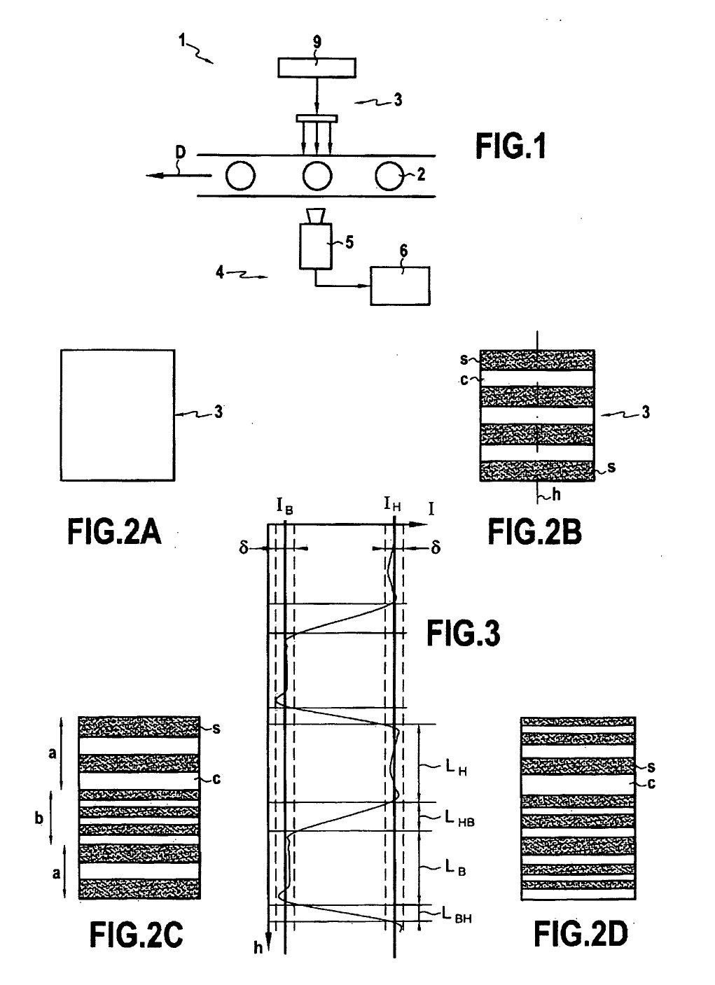

FIGS. 2A and 2B respectively illustrate a first and second type of illumination by a light source conforming to the invention.

FIGS. 2C and 2D illustrate two exemplary embodiments of a first type of illumination.

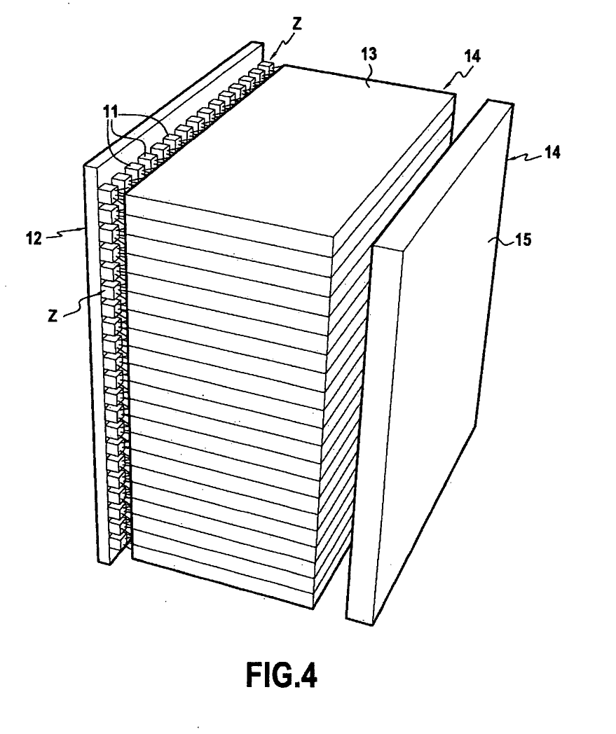

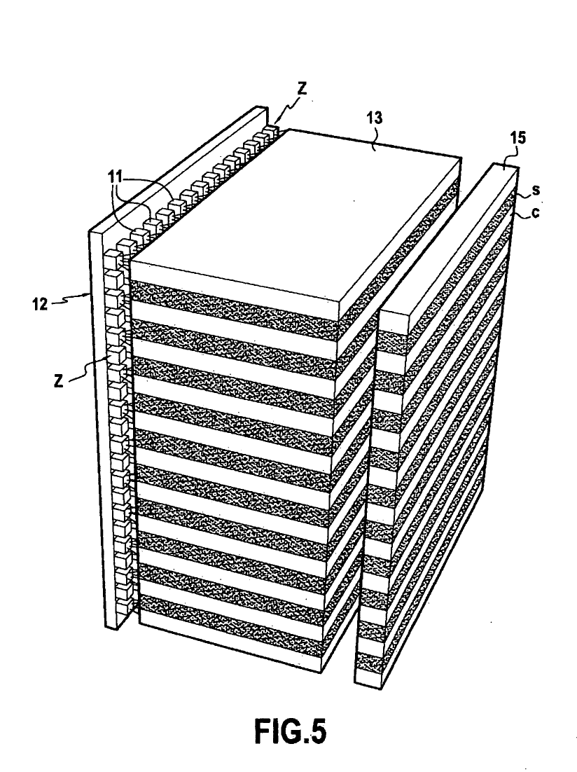

FIG. 3 illustrates the cycle of variation in level I of light from a second type of illumination of the source conforming to the invention, in a spatial direction h.

FIGS. 4 and 5 illustrate an exemplary embodiment of a light source conforming to the invention producing two different types of illumination.

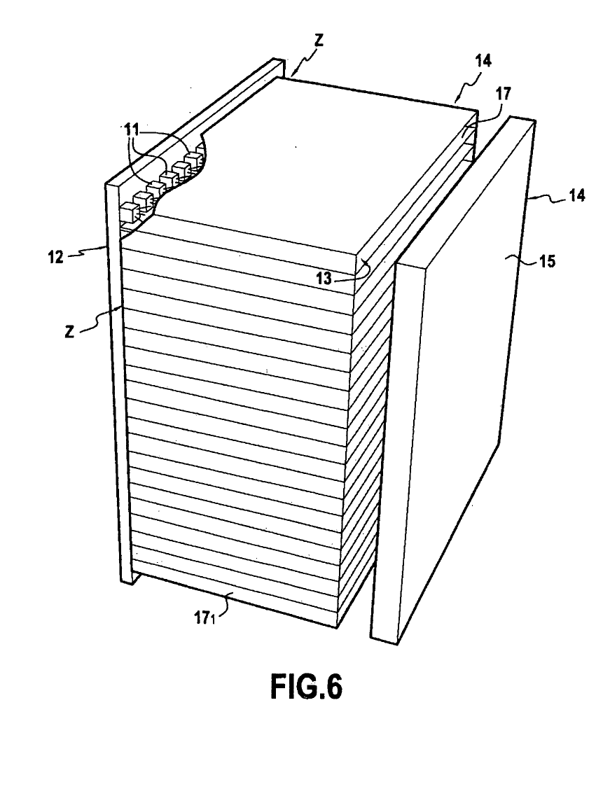

FIG. 6 illustrates another exemplary embodiment of a light source conforming to the invention which produces two different types of illumination.

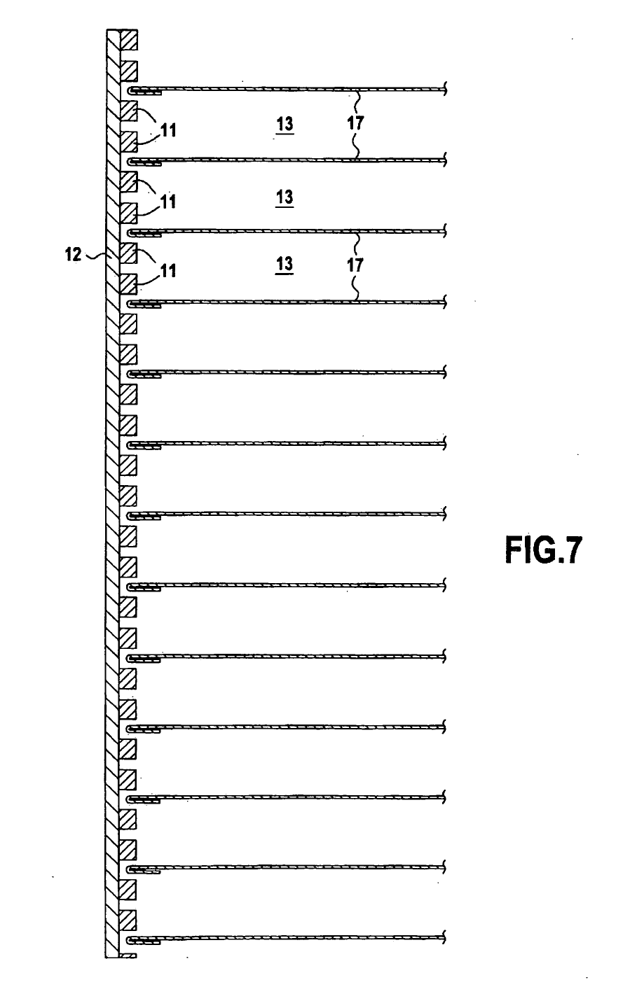

FIG. 7 is a sectional elevation view illustrating a characteristic detail of the light source shown FIG. 6.

As can be seen more clearly FIG. 1, the subject of the invention concerns an optical inspection device 1 for the line inspection of objects 2 travelling at a fast rate in a conveying direction D. For example, these transparent or translucent objects 2 are containers of bottle, flask or jar type in glass or plastic material. The optical inspection device 1 is able to detect defects in the walls of the objects 2. The optical station 1 comprises a light source 3 and means 4 to take and analyze images of the objects travelling between the light source 3 and the means 4. As is conventional, the means 4 consist of a camera 5 linked to a processing unit 6 processing the images in order to detect defects in the objects 2. The camera 5 can be a matrix camera or linear camera.

The optical inspection device 1 comprises means 9 to control the light source 3 so that said light source is able successively to produce, at fast speed, two types of illumination such as illustrated FIGS. 2a and 2B. The light source 3 is therefore controlled so as to produce a first type of illumination illustrated FIG. 2A, corresponding to homogeneous, uniform light illuminating at least all the parts of the object to be inspected. Also the means 9 control the light source 3 so as to produce a second type of illumination more particularly illustrated FIG. 2B and formed of alternate dark areas s and light areas c with discontinuous spatial variation. The dark areas s and the light areas c alternate in accordance with a pitch or cycle which may be periodic or non-periodic as will be explained in the remainder of the description.

In the example illustrated FIG. 2B, the dark areas s and the light areas c are alternate horizontal black and white stripes occurring in a periodic cycle. It is obvious that it may considered to form an alternation of dark areas c and light areas c that are not in horizontal stripes. For example it could be envisaged to form dark and light areas extending vertically, obliquely or in a pattern adapted to the objects to be inspected. It could also be contemplated to form black areas s and white areas c in chequered pattern, or an array of juxtaposed black and white areas.

FIG. 3 helps to explain the second type of illumination supplied by the light source 3. The cycle of spatial variation of level I of the light, in the transverse direction h to the alternate dark s and light c stripes, comprises the four following successive phases:
a phase P_{H} maintaining, over a length L_{H}, a high level of light intensity I_{H} at a substantially constant value,
a phase P_{B} maintaining, over a length L_{B}, a low level light intensity I_{B} at a substantially constant value,
a transition phase P_{HB} from high level intensity I_{H} to low level intensity I_{B} of length L_{HB}.
a transition phase P_{BH} from low level intensity I_{B} to high level intensity I_{H} of length L_{BH}.

It is to be noted that the lengths L_{HB}, L_{BH} of the transition phases are very short compared with lengths L_{B}, L_{H} of the phases maintaining the low and high intensities. In other words, the transition phases are steep with strong slopes so that lengths L_{HB}, L_{BH} tend towards a value of zero. Insofar as the lengths L_{HB}, L_{BH} tend towards zero length, the cycle of the light's spatial variation is said to be discontinuous.

It is to be considered that the low I_{B} and high I_{H} levels of light intensity are substantially constant i.e. having a minimum variation δ such that this variation δ is very small compared with the difference in level between the high and low intensities.

It is to be noted that the high level intensity I_{H} of the light areas c is at least sufficient to pass through the objects and to give a maximum signal level without saturating the camera. The high level intensity I_{H} is greater than the low level intensity I_{B}. Preferably, the high level intensity I_{H} of the light areas c is very high compared with the low level intensity I_{B} of the dark areas s. For example, the high level intensity I_{H} is at least twice greater than the low level of light intensity I_{B}. For example, the low level intensity I_{B} of the dark areas corresponds to no light.

In the example illustrated FIG. 2B, the second type of lighting provides an illumination with a periodic, cyclic spatial variation of constant value. A pair consisting of a light area c and a dark area s has a length (equal to the sum of the lengths of the four phases, namely L_{H}, L_{B}, L_{HB} and L_{BH}) which is equal to the lengths of the other pairs of light areas and dark areas. The spatial variation in light is therefore discontinuous as per a periodic cycle of constant value.

Evidently, the second type of lighting can provide illumination with a cyclical, periodic, spatial variation of non-constant value as illustrated FIG. 2C. In this case, the lengths of the pairs of light areas c and dark areas s are different. Therefore over at least one part, and in the example illustrated FIG. 2C over two parts a of its length, the light has discontinuous spatial variation as per a periodic cycle whose value is different from the periodic cycle of variation over part b. In the example, the length of the alternate dark and light stripes over part a is greater than the length of the alternate dark and light stripes over part b. With this solution, it is possible to adapt illumination to the different shapes which may be presented by the object to be inspected. It is to be noted that the second type of illumination may provide light having discontinuous spatial variation with a non-periodic cycle. In this case, the dark areas s and light areas c have lengths which vary without showing a repetitive cycle as illustrated FIG. 2D for example.

In the example illustrated FIG. 2A, the values of high level light intensity I_{H} are substantially identical for all the light areas c. Similarly, the low levels of light intensity I_{B} are substantially identical for all the dark areas s. Evidently, provision may be made so that the high level light intensity I_{H} (and/or low level I_{B} respectively) have separate values for different cycles i.e. for at least some of the light areas c (and/or dark areas s respectively). For example, provision may be made for the light source to have two levels of high light intensity for the different light areas c located in zones a and b respectively of the source illustrated FIG. 2C. Similarly, provision may be made for the light source to have two levels of low light intensity I_{B} for the different dark areas s located in zones a and b respectively of the source illustrated FIG. 2C.

FIGS. 4 and 5 illustrate a preferred exemplary embodiment of a light source 3 conforming to the invention. According to this example, the light source 3 consists of a series of elementary light sources 11 grouped into several adjacent zones Z independently controlled with respect to light intensity and/or illumination time. In the illustrated example, the elementary light sources 11 are arranged in horizontal rows each defining a zone Z of elementary sources 11. The elementary light sources 11 of one same zone Z are controlled simultaneously either with respect to illumination or to extinction. The elementary light sources 11 of a zone Z are controlled independently of the elementary light sources of the other zones Z. For example, the elementary light sources 11 consist of light-emitting diodes mounted on a printed circuit 12. In front of each zone Z, a light guide 13 is arranged adapted to guide the light emitted by the elementary sources 11 of zone Z as far as a transmission face 14. These light guides 13 therefore allow the light that is output to have homogeneous intensity. In the example of embodiment illustrated FIGS. 4 and 5 each light guide 13 consists of a parallelepiped in transparent material such as glass or a plastic material such as polycarbonate or polyacrylic. Each light guide 13 internally guides the light by channelling the light beams through successive reflections on its walls.

Advantageously, the light guides 13 are adjacent or juxtaposed. In the illustrated example, the light guides 13 are superimposed over each other, extending horizontally. It is to be noted that each light guide 13 channels the light beams preventing the light derived from an illuminated zone Z to pass into the light guide of an adjacent zone Z. If an illuminated zone lies adjacent to an extinguished zone, at the output a clear separation is seen between the illuminated zone and the extinguished zone. Advantageously, provision may be made to insert diffusers 15 on the pathway of the light to reinforce the homogeneity of illumination in each light guide.

FIGS. 6 and 7 illustrate another exemplary embodiment of light guides 13. According to this example of embodiment, each light guide 13 consists of a channel or chamber delimited by walls 17 of which at least some separate the light guides from each other. For example, provision may be made to form a box comprising a series of plates 17 in metal for example, extending parallel to one another and being held laterally in position by two side plates 17₁ extending perpendicular to the plates 71. For example, the sides opposites plates 17 are engaged in lumens arranged in the side plates 17₁ to ensure positioning of the plates 17. As shown FIG. 7, the side plates 17₁ are intended to be linked together by the printed circuit 12 which thereby forms the bottom panel of the box. The plates 17 are mounted so that they extend as far as the printed circuit 12 and may or may not be fixed to the printed circuit 12 to allow separation of the light from one light guide to another. Each light guide 13 is therefore delimited by two neighbouring parallel plates 17 and the parts of the side plates 17₁. According to this example of embodiment, each light guide 13 therefore has a straight, rectangular cross-section. For example, the two neighbouring parallel plates 17 are mounted either side of at least one, and for example of two rows of light-emitting diodes 12, so as to guide the light as far as the transmission face 14 located on the end edges of the plates opposite those lying close to the printed circuit 12. Evidently provision may be made to insert diffusers 15 on the pathway of the light, to reinforce the homogeneity of illumination within each light guide 13.

By controlling the elementary light sources 11 per zone, it is possible to obtain the illumination and/or extinction of said zone. Provision may therefore be made to achieve the first type of illumination by commanding the lighting of the elementary sources 11 of all the zones Z, leading to homogeneous illumination resulting from juxtaposition of the light guide outputs (FIG. 4). The light source 3 is able to provide the second type of illumination by alternate commanding of illumination-extinction per zones Z of the elementary light sources 13. This command leads to obtaining alternate dark areas s and light areas c, namely alternate black and white stripes as illustrated FIG. 5.

The light source 3 of the invention may be designed differently. For example, provision may be made to produce a uniform light source e.g. using an assembly of elementary sources such as light-emitting diodes arranged behind a diffuser. These elementary sources may be replaced by high frequency fluorescent tubes or by any other type of continuous or controllable light source. In front of this uniform source there is arranged a controllable element comprising several independent areas which may be made transparent or opaque as commanded electrically. Said function can be achieved by means of a liquid crystal display.

Similarly, the light source 3 can consist of a projection system projecting images onto a capture screen such as a video projector with liquid crystals or digital light processing. The system projects either a light homogeneous image onto the screen corresponding to the first type of illumination, or an image comprising alternating dark areas and light areas with discontinuous spatial variation corresponding to the second type of illumination.

According to another exemplary embodiment, the light source 3 may consist of elementary light sources grouped together into adjacent zones independently controlled with respect to light intensity and/or illumination time. Preferably the elementary light sources are organic light-emitting diodes (OLEDs).

According to one advantageous characteristic of embodiment, provision may be made to arrange an electrically controlled screen on the pathway of the light produced by the light source 3, that can assume either a transparent state when the source emits the second type of illumination, or a diffusing state when the source emits the first type of illumination. It is to be noted that said electrically controlled screen, that can assume two states, can be placed on the pathway of the light in the various embodiments of the light source 3 described above.

The inspection device 1 comprises means 4 used to take images of the objects illuminated by the two types of illumination. The means 4 also comprise means to process the images taken with the first and second types of illumination with a view to detecting high contrast defects and low contrast defects respectively.

The inspection device 1 of the invention also enables the detection of low contrast defects and the detection of high contrast defects to be combined in one single inspection station, without any lowering the performance level of these two types of detections. For this purpose, it is to be considered that the subject of the invention therefore allows the light source 3 to be controlled so that said source is able successively to produce two types of illumination, namely homogeneous illumination and illumination formed of alternating dark areas s and light areas c with discontinuous, cyclic spatial variation. The single light source 3 therefore, and at fast speed, successively produces the most uniform illumination possible followed by illumination having a markedly contrasted pattern e.g. alternating horizontal black and white stripes. The camera 5, successively and rapidly, is able to take at least two images of the objects to be inspected travelling at fast speed in front of the inspection device conforming to the invention. These objects 2 undergo practically no movement between the two image shots and therefore remain within the field of the camera and the light source 3. The image processing unit 6 analyzes the images taken with the homogeneous source so as to detect sudden local variations in shades of grey, with a view to detecting high contrast defects. The processing unit 6 analyzes the images taken with the illumination consisting of alternate dark areas s and light areas c with discontinuous spatial variation, with a view to detecting low contrast defects. For the purpose, the unit 6 analyzes the images taken by detecting transitions of grey shades at the transition points of the black and white stripes.

It is to be noted that the inspection device may also comprise a linear or circular polarising filter in front of the light source 3, and a linear or circular filter in front of the image-taking means 4. Said filters can ensure the detection of stress-type defects.

The invention is not limited to the examples described and illustrated, since various modifications may be made thereto without departing from the scope of the invention.

1. Optical inspection method for the line inspection of transparent or translucent objects (2) travelling at fast rate between a light source (3) and means (4) to take images of the objects and to analyze the images taken, so as to detect defects in the objects, characterized in that it consists of:
controlling the single light source (3) so that said source successively produces two types of illumination for each object travelling in front of said source, the first type being homogeneous illumination whilst the second type is formed of alternate dark areas (s) and light areas (c) with discontinuous spatial variability,
taking images of each travelling object when each thereof is successively illuminated by both types of lighting,
and analyzing the images taken with the first and second types of illumination, with a view to detecting high contrast defects and low contrast defects respectively.

2. Method according to claim 1, characterized in that it consists of controlling the light source (3) so that the second type of illumination is formed of alternate dark areas and light areas with discontinuous spatial variability occurring in a periodic cycle, whether or not of constant value.

3. Method according to claim 1, characterized in that it consists of controlling the light source (3) so that the second type of illumination with discontinuous spatial variability, and for each cycle, comprises:
a phase (P_{H}) maintaining, over a nonzero length (L_{H}), a high level of light intensity (I_{H}) at a substantially constant value,
a phase (P_{B}) maintaining, over a nonzero length (L_{B}), a low level light intensity (I_{B}) at a substantially constant value,
and transition phases (P_{HB}, P_{BH}) between the high and low levels of light intensity with respective lengths (L_{HB}, L_{BH}).

4. Method according to claim 3, characterized in that it consists of controlling the light source (3) so that the lengths (L_{HB}, L_{BH}) of the transition phases (P_{HB}, P_{BH}) tend towards zero duration.

5. Method according to claim 3, characterized in that it consists of controlling the light source (3) so that the high level of light intensity (I_{H}) is at least greater than the low level of light intensity (I_{B}) with the high level of light intensity (I_{H}) being at least sufficient to pass through the objects (2), whilst the low level of light intensity (I_{B}) tends towards a zero value.

6. Method according to claim 3, characterized in that it consists of controlling the light source (3) so that the high (and respectively low) levels of light intensity of the light areas (c) (and respectively dark areas (s)) have separate values for different cycles.

7. Device for the optical line inspection of transparent or translucent objects (2) travelling at fast rate between a light source (3) and means (4) to take images of the objects and to analyze the images taken, so as to detect defects in the objects, characterized in that it comprises:
means (9) to control the single light source (3) so that said light source successively produces two types of illumination when each object travels between the light source (3) and the image taking and analysis means (4), the first type being homogenous illumination whilst the second type is lighting formed of alternate dark areas (s) and light areas (c) with discontinuous spatial variability,
and means (4) to take images of each object illuminated by both types of illumination and to process the images taken with the first and second type of illumination, with a view to detecting high contrast defects and low contrast defects respectively.

8. Inspection device according to claim 7, characterized in that the light source (3) consists of a series of elementary sources (11) grouped into adjacent zones (Z) independently controlled with respect to light intensity and/or illumination time, a light guide (13) being arranged in front of each zone so as to obtain light of homogeneous intensity at the output of each guide.

9. Inspection device according to claim 8, characterized in that each light guide (13) is formed of a parallelepiped of transparent material.

10. Inspection device according to claim 8, characterized in that each light guide (13) is formed by a channel delimited by walls of which at least some separate the light guides from each other.

11. Inspection device according to claim 8, characterized in that at least one diffuser (15) is inserted on the pathway of the light emitted by the elementary sources.

12. Inspection device according to claim 7, characterized in that the light source (3) is formed of a uniform light source in front of which a liquid crystal display is placed that is controlled so as to make determined areas opaque or transparent.

13. Inspection device according to claim 7, characterized in that the light source (3) consists of a system projecting images onto a capture screen, which correspond either to a homogeneous light-coloured image or to an image comprising alternate dark areas and light areas with discontinuous spatial variability.

14. Inspection device according to claim 7, characterized in that the light source (3) consists of a series of organic light-emitting diodes grouped into adjacent zones (Z) independently controlled with respect to light intensity and/or illumination time.

15. Inspection device according to claim 8, characterized in that a screen controlled electrically to assume either a transparent state or a diffusing state is arranged on the pathway of the light of the light source.

16. Inspection device according to claim 7, characterized in that the light source (3) consists of elementary sources grouped into zones controlled independently with respect to light intensity and/or illumination time, a screen controlled electrically to assume either a transparent state or a diffusing state being arranged on the light path.

17. Inspection device according to claim 7, characterized in that it comprises a linear or circular polarizing filter in front of the light source, and a linear or circular filter in front of the image taking means.
